(19) United States
(12) Patent Application Publication
(10) Pub. No.: US 2022/0326264 A1
(43) Pub. Date: Oct. 13, 2022

(54) INTERSTITIAL PRINTING OF MICROARRAYS FOR BIOMOLECULAR INTERACTION ANALYSIS

(71) Applicant: Carterra, Inc., Salt Lake City, UT (US)

(72) Inventors: Joshua W. Eckman, Woods Cross, UT (US); Bruce K. Gale, Taylorsville, UT (US); Christopher Morrow, Layton, UT (US); James Smith, Yardley, PA (US)

(73) Assignee: Carterra, Inc., Salt Lake City, UT (US)

(21) Appl. No.: 17/224,448

(22) Filed: Apr. 7, 2021

(51) Int. Cl. G01N 35/00; G01N 35/10

(52) U.S. Cl. CPC G01N 35/00029; G01N 35/1011; G01N 2035/00158; G01N 2035/00039; G01N 21/63

(57) ABSTRACT

A flow cell applicator system can include a flow cell applicator including multiple flow cells to deposit multiple substance spots on a deposition surface, and a positioning assembly to position, to dock, and to unlock the multiple flow cells relative to the deposition surface. The substance spots can be depositable when the multiple flow cells are docked on the deposition surface. The flow cell applicator system can also include a spot deposition identifier operably associated with a processor to: record data related to substance spots as applied on the deposition surface, identify data related to substance spots previously deposited on the deposition surface, or both.

### BACKGROUND

Biomolecular interaction sensing and imaging systems are commonly used by researchers in the academic, pharmaceutical, and biotechnology sectors to observe, evaluate, and/or characterize binding interactions, e.g., antibody characterization, proteomics, vaccines, immunogenicity, biopharmaceutical development and production, etc. Numerous commercial biosensor instruments based on microarray approaches are available, including label-free biosensor and flow-through cell instruments, as well as other “printing” systems, e.g., pin printing, piezo printing, and microfluidic array printing, Typically, after applying the material(s) of interest on a substrate (ligand or similar substance), the sample (analyte) is loaded onto the biosensor where a binding interaction between the ligand and the sample occurs which can be further evaluated or characterized, or alternatively, no binding is observed which can be noted. Typically, thousands of interactions need to be analyzed, which often requires multiple sensor chips with limited sensing area, and limited numbers of interaction spots need to be prepared and analyzed. This process is very time consuming, expensive, requires significant quantities of difficult to acquire supplies (substrates, ligands, analytes, reagents), and often adds additional steps for the cross-validation of sensor chips and multiplexing or scaling up of assays to evaluate many samples and test fluids simultaneously. As a result, many currently available instruments are not suited for scale up or multiplexing of sensor data, particularly in real or near-real time. Reliable, high density microarrays are desired to provide effective high throughput analysis of bio-molecular interactions.

### BRIEF DESCRIPTION OF THE DRAWINGS

FIG. 1 is a schematic cross-sectional view of an SPR sensor including example sensorgrams in accordance with the present disclosure;

FIG. 2 is a schematic cross-sectional view of a flow cell applicator system with multiple flow cell applicators, e.g., a multi-flow cell (MFC) applicator and a large flow cell (LFC) applicator, which illustrates interstitial spot application and other application schemes, in accordance with the present disclosure;

FIG. 3 is a perspective view of a portion of the flow cell applicator system of FIG. 2 with example arrays of spots and large flow cell (LFC) spots applied on an assay surface of a bio-sensor;

FIG. 4 is a schematic cross-sectional view of a flow cell applicator system, which further illustrates an example interstitial spot application, in accordance with the present disclosure; and

FIG. 5 is a schematic cross-sectional view of a portion of an example SPR sensor in accordance with the present disclosure.

### DETAILED DESCRIPTION

In accordance with examples of the present disclosure, the present disclosure provides system, apparatus, method, application to high throughput binding reaction observations, evaluations, characterization, etc. The systems of the present disclosure can utilize and/or include various combinations of sensor systems, optical detection systems, fluidic systems, spatial sensor addressing systems, area sensor interfacing systems, data management systems, control systems, etc. At a high level, the systems can operate or be implemented by interacting spots of a sample substance and/or a ligand on an assay surface with an analyte substance applied using a flow cell array (applied in either order). For this system, a “flow cell” is a chamber with an inlet channel and an outlet channel through which fluids of interest can flow and be observed. In this work flow cells are formed when a cavity with an inlet channel and an outlet channel through which a fluid of interest can flow is pressed against another surface that completes the flow cell chamber. The flow cell is where measurements or observations of the flow and particles in the flow can be performed. Surface interactions, such as binding reactions, can also be observed in the flow cell. These observations are typically optical, such as SFR, absorbance, refraction or other optical effects, but other physical phenomena to understand what is happening in or passing through the flow cell can be used. For the purposes of this document, a flow cell can exist even if observation does not occur, such as when a flow cell chamber is formed and materials are deposited or removed by the flow cell on the adjoining surface, which is typically used as a sensing surface.

In accordance with examples of the present disclosure, a flow cell applicator system can include a flow cell applicator with multiple flow cells to deposit multiple substance spots on a deposition surface. These deposited substances are typically a ligand and can generally be considered as equivalent. The flow cell applicator system can further include a positioning assembly to position, to dock (or mechanically join in a prescribed position), and to undock the multiple flow cells relative to the deposition surface, wherein the substance spots are depositable when the multiple flow cells are docked on the deposition surface. Furthermore, the flow cell applicator system can include a spot deposition identifier operably associated with a processor to: record data related to substance spots as applied on the deposition surface, identify data related to substance spots previously deposited on the deposition surface, or both. Recording of data can be related to mapping spots applied to the deposition surface, and/or storing data associated with the applied spots. On the other hand, identifying spots can be related to finding spots already applied, either by using the mapped locations to re-find spots that were previously applied, or by sensing spots (or compositions of spots) previously applied.

In another example, a method of applying substances for analysis can include multiple steps, such as docking multiple flow cells of a flow cell applicator onto a deposition surface and flowing sample fluids through the respective flow cells to deposit a first group (which may be referred to as an “array”) of multiple substance spots on the deposition surface. The method can further include unlocking the flow cell applicator, re-docking the flow cell applicator or docking a second flow cell applicator, also including multiple flow cells, at an interstitial location on the deposition surface relative to the first group of multiple substance spots, and flowing sample fluids through the multiple flow cells after re-docking or from the second flow cell applicator to form a second group of multiple substance spots. In some more specific examples, the method can include engaging a spot deposition identifier with the deposition surface, the flow cell applicator, deposited substance spots; or a combination thereof to record data related to substance spots as applied on the deposition surface, to identify data related to substance spots previously deposited on the deposition surface, or both. In this context, the second group of multiple substance spots can be applied to the deposition surface and be interstitially positioned relative to the first group of multiple substance spots.

In further detail, regarding the flow cell applicator systems and/or methods described above, data that is recorded by the spot deposition identifier may include locations of substance spots as deposited on the deposition surface, sizes of substance spots as deposited on the deposition surface, area covered by substance spots as deposited on the deposition surface, identities of substance spots at the locations, groups of substance spots with a common property, deposition quality of substance spots as deposited on the deposition surface, or a combination thereof. On the other hand, identifying spots on a deposition surface may include identifying locations of substance spots as deposited on the deposition surface, identifying the identity of previously deposited location spots, e.g., identifying a composition component or makeup of a substance spot at the locations, identifying groups of substances spots with a common property, or a combination thereof. Identification of these substance spots, e.g., locations, composition, groups, etc., can be by the use of an optical or some other type of sensor, such as by using reference marks, can be by mapping locations stored by the processor, or may include reference signals for comparison against substance spots to identify compositional properties of a substance spot, for example. When sensing without using the data previously mapped, but using a sensor, such as when an optical sensor is included as part of the spot deposition identifier, sensing can be based on images of the surface or variation of a sensed signal.

In some examples, the deposition surface can be included as part of the flow cell applicator system, or may be separate from the flow cell applicator system. The deposition surface is used with respect to the method, whether or not it is part of the system or part of a separate system. In one example, the deposition surface can include an assay surface of an optical sensor. In another example, an optical sensor used as part of the deposition surface can be a Surface Plasmon Resonance (SPR) sensor. In still further detail, the multiple flow cells can be arranged on the flow cell applicator to apply a high-density microarray of deposited spots, which may be defined herein as including an average of at least 1 spot per mm². In some more specific examples, the high-density microarray of deposited spots may be used that can be defined as including spots with spacing (center-to-center) of about 0.5 mm or less, which may be equivalent to about 1.8 spots per mm², In some more detailed examples, spacing from about 0.1 mm to about 0.4 mm, or from about 0.2 mm to about 0.3 mm (in at least one direction) can be used. Thus, spot densities can be from about 2 to about 4 spots per mm², or from about 2.5 spots to about 3.5 spots per mm². In further detail, in one example, the high-density microarray can include spatial separation between immediately adjacent flow cells so that they do not overlap. Thus, the spatial separation can be sufficient so that biomolecular interactions occurring at various locations of individual substance spots do not interfere with immediately adjacent biomolecular interactions occurring at immediately adjacent substance spots. Alternatively, the flow cell may be arranged such that the deposited spots are immediately adjacent to each other.

In still further detail, the positioning assembly can be operable to cause the multiple flow cells of the flow cell applicator to: translate the multiple flow cells along an x- or y-axis relative to the deposition surface, wherein translation along the x- or y-axis includes lateral translation along an x-axis, a y-axis, or a combination of the x-axis and the y-axis translation relative to a deposition surface, and translate the multiple flow cells along a z-axis relative to the deposition surface, wherein translation along the z-axis includes movement to dock and to undock the multiple flow cells relative to the deposition surface. For example, movement to dock the multiple flow cells can result in closing the recessed chambers of the multiple flow cells by pressing the multiple flow cells at the recessed chambers against the deposition surface with sufficient force to seal the multiple flow cells against the deposition surface, and movement to undock the multiple flow cells includes separating the multiple flow cells at the recessed chambers from the deposition surface with sufficient clearance for x-axis translation, y-axis translation, or both x-axis and the y-axis translation. The positioning assembly can be automated to dock and undock the multiple flow cells relative to the deposition surface, for example. The positioning assembly can likewise be controlled to dock and undock the multiple flow cells at a plurality of locations relative to the deposition surface, such as at arbitrary or predetermined locations. The plurality of locations can include a first location on the deposition surface and a second interstitial location on the deposition surface relative to the first location upon x- or y-axis translation and z-axis translation of the flow cell applicator. The x- or y-axis translation, in some examples, can include both x- and y-axis translation. An interstitial location would be a spot location between previously printed spots on the deposition surface in either the x- or y-directions.

The multiple flow cells can be spatially aligned as an array in rows and columns along the x- and y-axes, for example. In some examples, the array can provide for sufficient spacing between adjacent flow cells for interstitially applying a group of (additional) spots relative to an initially applied group of substance spots without overlap. These can be considered to be applied at a second interstitial location (relative to the substance spots applied at the first location). To be clear, the first substance spots applied as an array are referred to as being applied at a “first location.” However, when referring to subsequently applied arrays of substance spots, they are referred to as being applied at “interstitial” locations, e.g., second interstitial location, third interstitial location, and so forth. Thus, when applying arrays of substance spots, the first array applied is referred to as being applied at the “first location,” the second array applied is at the “second interstitial location,” the third array applied is at the “third interstitial location,” and so forth. To be clear, “the second interstitial location” refers to the second group of substance spots applied, but this group of substance spots is the first group applied interstitially. As mentioned, with respect to the plurality of locations, in some examples, this can further include a third interstitial location where a group of substance spots are deposited on the deposition surface relative to the first location and/or the second interstitial location. In still further detail, in addition to the first location, the second interstitial location, and the third interstitial location, there can be a fourth (or more) interstitial location, e.g., an eighth interstitial location, a twelfth interstitial location, etc. Interstitial locations can be where substance spots are applied relative to the first location (or the location of other interstitial locations) based on x- or y-axis translation and z-axis translation of the flow cell applicator relative to a previously applied group of substance spots at the first location or subsequently applied group of substance spots at another interstitial location.

As a further point of clarity, when multiple flow cells of a single flow cell applicator are used to apply a plurality of substance spots to a deposition surface, the term “group” or “grouping” may be used to describe the collection of individual flow cells and/or deposition spots applied to a deposition surface from a common flow cell applicator. These groups of flow cells and/or deposition spots may be in the form of a random or patterned grouping, or may be in the form of a more ordered array, e.g., grid-like pattern with rows and columns.

In other examples, referring again to examples of the systems and methods described herein, it is noted that the multiple flow cells can have a length and/or width such that a whole number of individual flow cells can be interstitially printed between an initially applied group of substance spots without overlap in either the x or y direction. On the other hand, in some examples, a second interstitial location (or any other interstitial location) can be proximate enough to the first (or any other) previously applied group of substance spots, or proximate enough to the first location where substance spots were applied, that the substance spots at the second interstitial location partially overlap or contact at edges thereof an initially applied group of substance spots applied at the first location, e.g., the second set of spots applied.

In one example, interstitial application of substance spots can be by the same flow cell applicator, or alternatively, can be by a second flow cell applicator (or third, fourth, etc., flow cell applicator). The second (or third, etc.) flow cell applicator can be operably associated with the positioning assembly and controlled to dock and undock the multiple flow cells of the flow cell applicator and the multiple flow cells of the second flow cell applicator to provide for application of substance spots generated by the flow cells of the second flow cell applicator to be applied at a second interstitial location relative to application of substance spots generated by the multiple flow cells of the flow cell applicator.

In some examples, the second flow cell applicator can be a larger flow cell applicator. The term “larger flow cell applicator” refers to flow cell applicators that apply substance spots having a larger application area (per substance spot) than the other previously described (first) flow cell applicator. Thus, the larger flow cell applicator can be sufficiently large to overlay a plurality of substance spots applied by the (first) flow cell applicator. The larger flow cell applicator may have one flow cell that applies substance spots at each print event, or may include multiple flow cells that apply substance spots at each printing event. For example, the larger flow-cell applicator assembly may print larger substance spots to cover or overlap from 2 previously applied substance spots to all of the previously applied substance spots, e.g., covering 2, 4, 8, 16, 32, 64, 128, 256 previously applied substance spots, or any number of substance spots from 2 to 256, from 4 to 256, or from 8 to 256 previously applied substance spots.

In further detail regarding the systems and methods described herein, the multiple flow cells of the flow cell applicator (and/or the second, third, fourth, etc., flow cell applicator) can have an aspect ratio from 3:2 to 20:1, from 3:2 to 10:1, or from 2:1 to 10:1, for example. In one example, the flow of fluid into and out of the individual flow cells can be in a direction corresponding to the longer dimension, e.g., length, of the respective flow cell. The aspect ratio is the ratio of the length of the flow cell to the width of the flow cell and the width or length can be in either the x or y direction.

In further detail, the multiple flow cells can be individually associated with a fluid microchannel to flow sample liquid through the flow cell using the microchannel, and in some other examples, may be individually associated with secondary microchannels for flowing other fluids through the respective flow cells. For example, a secondary flow channel can be used to flow a common liquid to multiple flow cells that may not be unique to that particular flow cell. This can be a bulk liquid that is used to contact many previously applied (or to be applied) substance spots. The secondary flow channels, on the other hand, can be unique to individual flow cells. For example, rather than using a bulk fluid for all of the flow channels, a second fluid could be used to flow into individual flow cells, or a sub-group of flow cells. In still other examples, the systems and methods can include or use air or gas microchannels for introduction of air or gas into the flow cell applicator system, such as to provide operational valving to the fluid microchannels, for example.

In accordance with these and other examples, it is noted that multiple substances can interact, e.g., react, such as ligands attached to an assay surface, sample substances applied as a spot on the assay surface, analyte or probe substances applied as a spot on the assay surface, etc. For example, there may be two substances, three substances, etc., that may interact. For purposes of describing such interactions, and for convenience, a first substance applied to an assay surface, whether applied by spot application or preloaded on an assay surface, can be referred to as a “first substance,” a second substance applied can be referred to as a “second substance,” and a third substance applied can be referred to as a “third substance,” and so forth, whether or not the substance is acting as a ligand, sample substance, or as an analyte, target, or probe substance.

As a further note, for simplification and clarity, the term “system” can be used herein generically to describe various aspects of the disclosure that relate not only to various recited systems per se, but also to apparatuses or devices, various device components, methods of use, methods of assembly, sub-systems, collections of devices working together, etc., to avoid cumbersome explicit statements throughout stating that an aspect of the disclosure relates to the various apparatuses, systems, methods, etc. In other words, describing “systems” herein can be applicable to the various types of systems, devices, methods of assembling, methods of using, etc. Likewise, it is also noted that when a more specific example is given regarding a method or apparatus, for example, details in that description can also be applicable to other aspects of the disclosure, e.g., method disclosure is applicable to the systems and apparatuses, etc.

As a general overview, the systems of the present disclosure can be used for Surface Plasmon Resonance (SPR) applications, but it is noted that in some examples related to the spot application of deposition spots for analysis, other types of sensors or sensing methods can be implemented with other flow cell applicator system examples, such as for example, interferometry, Common Path Interferometry, Surface Acoustic Waves, higher order harmonic detection, fluorescent detection, scanning probe detectors, Fourier transform infrared, ellipsometry, and other surface sensitive methods.

In a general orienting example that can be implemented in accordance with the present disclosure, a first group of substance spots of a first substance can be applied to an assay surface using a network of microfluidics for applying spots via flow cells fluidly coupled to the sensing surface. The flow cells can be effective for application of sample material in the form of sensing spots on an assay surface of a sensor chip, such as a sensor chip of a sensing system, or for flowing a sample with a potential substance of interest over the sensing spots. If the sensing system is an SPR sensor, a solid optical material, e.g., optical prism, can include a facial surface or surface to which a sensor material, e.g., thin layer of material such as gold, silver, etc., is applied or placed. The optical prism can allow light energy to enter the optical prism in a first direction, where the light is reflected from an optical interface surface (which is also the surface that reflects the light energy, sometimes referred to as a “reflecting surface”) of the sensor chip. The optical interface surface is opposite the assay surface, which is the opposing sensor chip surface where substance interaction occurs. Thus, sensing of the interaction on the assay surface does not occur from the assay surface, but from reflected light at the opposing optical interface surface. The light energy (in the form of “reflected light energy” carrying a dark resonance band of reduced intensity within the reflected light energy beam) can then exit the optical prism in a reflected second direction. In this arrangement, the optical prism and the sensor chip can be configured to be suitable for SPR applications. For example, the assay surface of the sensor chip (or of another type of sensing system if the sensor is not an SFR sensor) can be applied with spots of sample material of various types to test for interactions, for example, and the interactions can be detected from the optical interface surface.

To apply materials on the assay surface, pumps can be connected to or built into microfluidic channels suitable for applying sample material thereon. In one example, the microfluidic channels can be part of a network of microfluidic channels which can feed and return fluid from flow cells fluidly coupled therewith. A “flow cell” can refer to an individual spotter, and can include the chamber where a fluid, or a substance carried by a fluid, is applied to a deposition surface, such as a sensor surface or assay surface. The flow cell includes an orifice usually defined by a flow cell application interface that may include a gasket(s), e.g., gasket around a large flow cell (LFC) or multiple gaskets around multiple flow cells (MFC), or may include a continuous material that defines a single opening or multiple openings, for example. Thus, the chamber, regardless of the material that defines the chamber, can be docked against a deposition surface, such as an assay surface of the sensor chip, and sealed thereto for purposes of flowing sample fluid across the deposition surface. The sample fluid can be flowed into and out of the flow cell via one or more microchannels, but the microchannels are not part of the flow cell, per se. Rather, the microchannels and any chambers or wells that feed or receive fluid from the microchannels can be referred to collectively with the flow cell as a “flow cell fluidic circuit,” or “flow cell circuit.” If there are multiple flow cells arranged to deposit a group of substance spots on a deposition surface, they may be referred to as a “group” or as an “array” of flow cells. Thus, flow cells (with an open end for applying spots to a deposition surface) can include negative space that is defined in part by “flow cell application interface” as well as by the material not at the interface that also defines the flow cell chamber. The flow cell application interface can include or define a single flow cell, e.g., a single large flow cell, or can define a plurality of flow cells, e.g., from 2 to hundreds of flow cells, which can be arranged in array or other arrangement.

Regardless, flow cells can individually receive sample fluids, which can be directed onto the deposition surface as fluids to form deposition spots. The fluid(s) can be sample fluids which may include an analyte or probe substance carried by a fluid which may be a buffer fluid or other liquid vehicle carrier, using the pump(s) and microfluidic channels (one or more inlet and/or one or more outlet channels), which can be supplied by a multi-liquid circulation and/or storage system. In one example, circulation can include bi-directional flow between multiple containers (with open or closed configurations). During circulation, the substance(s) can be applied to the assay surface. Multi-liquid circulation and/or storage, in one example, can be a cartridge or other similar container that a user can insert and drive substances through the system (grouping or array of flow cells) and onto the assay surface. Once a spot is deposited using a flow cell applicator, the flow cell applicator may be disassociated with the deposition surface and replaced by a second flow cell applicator (or the same flow cell applicator can remain in place and used with a different substance, or even repositioned to another location for further deposition). The second fluid or substance application event, whether by the same flow cell applicator or a different flow cell applicator, can completely cover or partially cover, e.g., overlap, individual spots or group of substance spots. In another example, a larger flow cell applicator that covers a plurality of spots, e.g., 2 spots, 24 spots, 48 spots, 96 spots, 192 spots, 384 spots or any other number of spots; or a still larger flow cell that covers the entire group of substance spots previously applied on the assay surface can be used, in some examples. A second substance can be flowed through the second flow cell (or flow cells if more than one) and the interaction between the second substance and the first substance applied at the spot location can be observed, evaluated, measured, characterized, or the like. Third, fourth, or fifth substances (or any number) can likewise be flowed across the surface. Interactions between the flowing substance and previously bound substances can be observed. The sensor can be used, for example, to gather this type of information which can be processed onboard or can be processed using a separate computer or CPU system. In one example, the fluid operations including interactions on the assay surface, whatever they may be designed to be, can be observed and/or analyzed using the sensor, such as the SPR optical sensing systems described herein, often in real or near real time.

In accordance with one example of the present disclosure, the sensor used to detect the samples applied to the assay surface can be a Surface Plasmon Resonance (SPR) sensor that is suitable, for example, for detection and studying label-free biomolecular interactions in fields such as the life sciences, medicine, pharmaceutics, electrochemistry, chemical vapor detection, food and environmental safety, etc. SPR sensors can be used for a wide variety of substances, such as ions, small molecules, DNA, RNA, oligonucleotides, aptamers, proteins, antibodies, peptides, enzymes, fragments, liquids, liquid foods, chemicals, thin material layers, viruses, cells, extracellular vesicles, exosomes, bacteria, etc., and/or can provide a variety of information about substances carried by a fluid, such as molecules, ions, etc. Such information that can be observed, studied, or otherwise evaluated includes kinetics, binding, affinity, specificity, concentration, or other similar type of information without the requirement of labeling, or with labeling, if desired.

Thus, the present disclosure is drawn to systems, apparatuses, and methods for high throughput binding reaction observation, evaluation, characterization, and/or other useful output of information. In one example, the present disclosure sets forth a flow cell applicator system, including a multi-flow cell (MFC) applicator assembly comprising multiple flow cells arranged in an array with open ends of the respective flow cells positioned along a plane of a flow cell applicator, and a positioning assembly operably associated with the multi-flow cell applicator. The positioning assembly can be configured for x- or y-axis translation (or translocation) of the flow cell applicator, wherein x- or y-axis translation includes lateral translation along an x-axis, y-axis, or a combination of the x-axis and the y-axis relative to a deposition surface. For example, y-axis translation may be translation from right to left when looking at a front surface of the flow cell applicator, and x-axis translation may be from front to back when looking at the front of the flow cell applicator system. X-axis translation and y-axis translation are arbitrary, as side to side or front to back could be assigned either x-axis or y-axis, and vice versa. However, z-axis orientation can be defined herein to be the parallel to the direction of joining of flow cell application interface with the deposition surface, which in many cases is vertical, but this is not required. Typically, the z-axis is perpendicular to the deposition surface. Thus, the positioning assembly can be configured for z-axis translation of the flow cell applicator relative to the deposition surface, wherein z-axis translation includes the translation direction perpendicular to the surface of the deposition surface suitable for flow cell application interface docking and undocking with respect to the deposition surface.

Docking can include closing the open ends or cavities of the flow cells by pressing the flow cell application interface against the deposition surface with sufficient force to seal the flow cells against the deposition surface. Undocking can include separating the flow cell application interface from the deposition surface with sufficient clearance for x- or y-axis translation. The positioning assembly can be adapted for docking at a plurality of locations on the deposition surface. In one specific example, the plurality of locations can include a first location on the deposition surface and a second interstitial location on the deposition surface relative to the first location (upon x- or y-axis translation and z-axis translation of the flow cell applicator). In one example, the x- or y-axis translation can include the ability for both x- and y-axis translation. Furthermore, the grouping (or array) of flow cells can be spatially aligned in rows and columns along the x- and y-axes, and there can be sufficient spacing between adjacent flow cells for interstitially applying a group of substance spots relative to an initially applied group of substance spots without overlap. In another example, the second interstitial location can be proximate enough to the first interstitial location that an interstitially applied group of substance spots applied at the second interstitial location partially overlaps with an initially applied group of substance spots applied at the first location. In one example, the deposition surface can be part of the system, with the deposition surface operationally positioned relative to the multi-flow cell application interface(s) for applying the initial group of substance spots and an interstitially applied group of substance spots on the deposition surface. In still other examples, a second flow cell applicator can be operably associated with the positioning assembly. In one example, the second flow cell applicator includes a flow cell sufficiently large to overprint or overlay a plurality of spots applied using the multi-flow cell (MFC) applicator, e.g., the second flow cell applicator can be a large flow cell (LFC) applicator assembly.

For clarity, a “multi-flow cell applicator” or “MFC applicator assembly” can include an assembly for directing fluid to a printhead, such as a contact printhead or spotter, with two or more flow cells for printing multiple spots on a deposition substrate, e.g., a sensor substrate, from a common flow cell application interface. The MFC applicator may arrange these multiple flow cells in any pattern, array, random configuration, etc. In many instances, an MFC applicator or spots printed therefrom can be referred to herein as an “array,” but it is understood that this does not infer any specific type of order or pattern.

A “large flow cell applicator” or “LFC applicator assembly” can include an assembly for directing fluid to a printhead, such as a contact printhead or spotter, with a flow cell that is large enough to overprint (or pre-print) with overlap sufficient to cover multiple spots laid down by the individual flow cells of the multi-flow cell applicator.

In further detail, a second flow cell applicator can be operably associated with the positioning assembly, and the second flow cell applicator can likewise include a grouping (or array) of flow cells that are spatially aligned in rows and columns along the x- and y-axes. Thus, the (first) flow cell applicator can be two different multi-flow cell applicators, or can be a multi-flow cell applicator and an LFC applicator assembly. There can be sufficient spacing between adjacent flow cells along one of the x- or y-axes for interstitially applying a group of substance spots relative to an initially applied group of substance spots deposited by the first multi-flow cell applicator.

In further detail, the deposition surface can be an assay surface of an SPR sensor. In still another example, the assay surface, the positioning assembly, or both, can be operably associated with a spot deposition identifier, e.g., optical sensor, mapping, etc. For example, the spot deposition identifier can include a processor that works with a sensor, e.g., optical, electromagnetic, chemical, etc., which uses mapping logic, e.g., digital or mechanical memory of deposition sites, etc., to map spot locations, find previously deposited spot locations, identify spot substances applied, and identify current or previous experiments, optical landmarks, alignment marks, etc., or any combination of these techniques or other similar techniques thereof. In one example, the spot deposition identifier can be used in combination with the positioning assembly and any positioning data, sensory or otherwise, along with a processor, so that image processing, optical or otherwise, can be used to identify spot locations, for example.

Multiple flow cells can be individually associated with an inlet microchannel and an outlet microchannel for flow sample fluid through the flow cell from the inlet microchannel, through the flow cell, and out of the outlet microchannel. In another example, multiple flow cells can be individually associated with a second inlet microchannel for flowing a second fluid through the respective flow cells, and the multiple inlet microchannels can be adapted for queuing fluids sequentially into their respective flow cell. In particular, this arrangement might include multiple inlet channels where one of the inlets is connected to a reservoir of fluid intended to be delivered to all flow cells. This secondary inlet channel might be a branched channel that connects to multiple flow cells. The other inlet channels would be for delivering samples, substances, or fluids only to that specific flow cell and would not include any branches. There can be also multiple inlet channels with outlet channels feeding a common waste well or vessel. In addition to fluidic channels for flowing liquid sample fluid into and out of the various flow cells, there can be fluidic channels for air or gas valving control of the (liquid) fluidic movement.

Notably, the application system described herein can be adapted to methods of printing or application of spots, apparatuses, sub-systems, or the like without departing from the scope of the present disclosure. For example, a method of applying depositing substances can include docking a flow cell application interface of a flow cell applicator onto a deposition surface treated with a first substance, wherein the flow cell applicator can include multiple flow cells arranged in an array with open ends of the respective flow cells positioned along a plane of the flow cell application interface. The method can also include flowing sample fluids through the respective flow cells to deposit secondary substances on the deposition surface as a group of substance spots in contact with the first substance. Another step can include, with a positioning assembly, unlocking the flow cell application interface followed by re-docking the flow cell application interface or a second flow cell applicator also including multiple flow cells at an interstitial location on the deposition surface relative to the group of substance spots. In this example, the method can also include flowing sample fluids through the flow cells to form a second group of substance spots interstitially positioned relative to the group of substance spots.

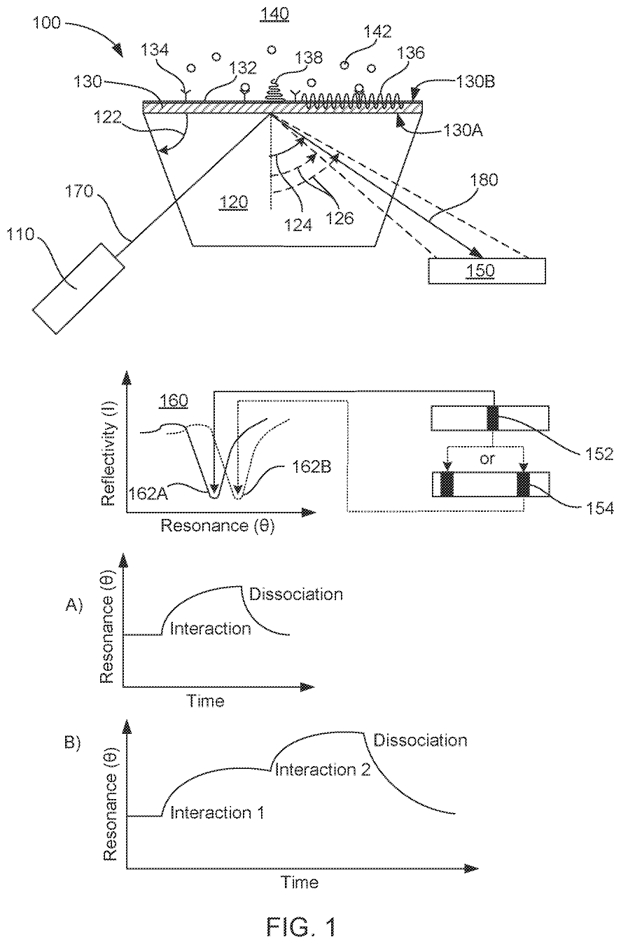

In accordance with this, as shown in FIG. 1, an optical sensing system 100 (which can be an SPR system) is shown that includes a light source 110 (or emitter), which can be a broadband source, a Light Emitting Diode (LED), a laser, or other standard light sources. The emitter can be positioned to emit light energy 170 into a solid optical material 120, e.g., optical prism. In one example, the legs of the trapezoid on the prism can form a 60° to 80° prism side-wall angle 122 (relative to a “face” surface of the optical prism that is the surface that interfaces with the optical interface surface of the sensor chip), and the angle can be selected more specifically to coordinate with a nominal resonance angle at or near the center of a desired or predetermined measurement range. After the light energy enters the solid optical material, the light can be reflected 180 from an optical interface surface 130A (or reflecting surface) of a sensor chip 130, e.g., thin film, coupon, grating, etc., applied to or placed on a facial surface of the optical prism. The sensor chip, in some instances, can be a modular removable coupon or grating or some other structure that is removable and/or can be placed on the solid optical material, and in other instances, can be joined or fastened to the optical prism with adhesive, applied as a film, can be fastened to the solid optical material, etc. As a note, the “face” surface of the optical prism can be defined as the large surface that interfaces with the optical interface surface of the sensor chip, where light enters and exits the optical prism, and the reflected light is then captured or sensed by a detector 150 (or camera, which can be a video camera, for example). The detector can be sensitive to light intensity, polarity, and/or other properties of the light which can be sent to a computational system for analysis and/or display. The angle of reflection is the angle at which the reflected light leaves the optical interface surface and can be adjusted to find a resonance angle 124, which is the angle at which the beam of reflected light is primarily absorbed by the electrons of a sensor chip at a given location on the surface. The angle of incidence refers to the angle of the incoming light energy beam relative to the prism surface and that leads to reflection from the optical interface surface of the sensor chip.

Notably, the optical sensing systems described herein can be adapted to methods, apparatuses, sub-systems, or the like without departing from the scope of the present disclosure. For example, a method of sensing an interaction(s) of substances using the optical sensing system described herein can include applying multiple substances to the assay surface to test for one or more interaction of the multiple substances when contacted; and detecting the light energy emitted from the emitter and reflected from the sensing substrate at the detector. The method can be based on an SFR configuration, or some other optical arrangement where light energy can be used to sense substance interactions on a deposition substrate. Thus, the discussion of SPR herein is used by example and as a proxy for other optical detection arrangements, and thus, could be substituted for other optical detection systems that may utilize light energy to detect substance interactions, such as those listed elsewhere herein.

When configured for SPR, a baseline reading can be taken with any supplemental coating 132 (e.g., dextran coatings, carboxymethyl dextran coatings, hydrogel coatings, polyethylene glycol/carboxyl coatings, nickel nitrilotriacetic acid coatings, hydrophobic alkyl coatings, polycarboxylate coatings, protein coatings, self-assembling monolayer coatings, streptavidin coatings, etc.) that may be present on the assay surface or in the solution above the surface, as well as the (immobilized) ligands 134 that may be pre-loaded on the sensor chip. Resonating electrons can be referred to as surface plasmons, shown by example as plasmon wave 136. The location of the (initial) resonance at the detector 150 can be established based on an initial resonance dip 162A in the SFR Reflection Intensity Curve 160, which can also be represented by an initial dark band 152 indicating the area on the detector where resonance is detected, e.g., reduced reflection due to resonance of the sensor chip. After interaction between the analyte 142 and the ligands 134 on a surface of the assay surface 130B, the location where resonance occurs shifts over time to the right or left, as indicated in FIG. 1 by a second dark band or SPR dark band 154, and further illustrated by SPR dip 162B. The shift in angle over time can provide information about the interaction between any of a number of substances that may be present on the assay surface. Notably, the resonance indicated by the second dark band is not static but can move laterally over time (see graphs A and B in FIG. 1 for relationship between resonance and time) as the interaction dynamics on the assay surface change.

In more specific detail, the SFR Reflection Intensity Curve 160 can plot reflectivity (refractive index I) against the resonance (or absorbance) angle (θ) of the sensor chip, e.g. gold film or coupon. Thus, the shape and location of the SFR dip can convey information about the assay surface via interaction with the optical interface surface prior to introduction of the analyte. As the angle of resonance dynamically shifts, additional information can be gathered that is compared to the initial readings. For example, as a sample fluid 140 with an analyte or probe substance of the sample fluid is passed along the assay surface 130B of the sensor chip (which may include a supplemental coating), the ligand associated with the assay surface interacts with the analyte and the dark band and the SPR reflection intensity curve shifts to the right or to the left. The new angle where resonance occurs can be referred to as the surface plasmon resonance angle 126 (which may shift to the right or the left). As a note, the ligand can be pre-applied to the assay surface, or it too can be deposited to the assay surface using flow cells of a flow cell applicator system, for example. Referring again to the assay surface (the surface opposite the reflecting/optical interface surface), also shown in an evanescent wave 138 to illustrate that as the substance or analyte, carried by fluid, gets closer to the assay surface, the sensitivity is increased. Thus, in one example, interactions can be evaluated within about 100 nm of a surface of the sensor chip (or supplemental coating that may be present to assist with attaching ligands to the assay surface of the sensor chip). As a note, the analyte, in some examples, can be referred to as a target, probe, or generally as a substance. Furthermore, there may be one analyte, target, substance, etc., used in an assay, and thus, can be referred to herein as a “first” substance, “second” substance, “third” substance, etc. respectively. Substances can be present on or applied to a sensing substrate, or can be applied as a spot within a fluidic sample, or by any other technique sample application or interaction.

SFR can be used to observe time dependent interaction between ligands and analytes or probes. By monitoring response over time, kinetics of molecular binding can be evaluated and characterized. Kinetics can be shown by plotting the resonance (or absorbance) angle (θ) against time. The magnitude of the units of time used can depend on the interaction speed. This is shown by simple example in graph A of FIG. 1. As an interaction starts at the beginning contacting an analyte or probe with a ligand, initial binding tends to be more rapid because there are more sites available for binding. Once the sites begin to fill up, the binding slows down and may eventually level off as equilibrium (binding to unbinding) occurs. Dissociation begins to occur when analyte introduction slows, stops, or a disassociate chemical or wash is introduced. In a simple example, an associate constant (Ka) and a dissociation constant (Kb) can be determined and a ratio (Ka:Kb) can be established. Other types of information can also be determined, as previously mentioned. In further detail, in graph B, two interactions may occur, such as when two materials are sequentially introduced. Thus, there are a variety of types of experiments or interactions that can be conducted using resonance information compared to time, many of which are not specifically shown in this FIG.

In addition to the solid optical material, e.g., optical prism, mentioned previously, an optical system can include a light source, optical components to direct the light from a light energy source onto the optical interface surface (typically in accordance with principles of SPR instruments). The optical interface surface can be referred to as the “reflecting surface,” as the angle change of reflected or non-reflected light can be measured using SPR (from the bottom surface as shown in the FIGS), even though the chemical interactions occur on the assay surface (e.g., the top surface as shown), As a note, the terms “top” and “bottom” are used for convenience to orient the FIGS. shown with the specification, and refer to general orientations in some examples but can be positioned in any other orientation, included in an inverted orientation or orientations that are not necessarily vertically aligned above one another. Thus, “top” and “bottom” are used for convenience and understanding and do not infer orientation, but rather relative location with respect to one another in certain examples, but should be inferred to include any other orientation with similar relatively positioned structures. In further detail, the light energy that reaches the optical interface surface can be reflected as modified light energy due to interaction with the sensor chip and/or chemical interaction that can be occurring just above the optical interface surface on the assay surface, e.g., modified by the introduction of resonance (or light absorption). Thus, as reflected (and modified) light energy exits the solid optical material, e.g., optical prism, a detector 150 or camera can then collect information related to light intensity of the reflected beam of light energy, particularly noting the location and intensity of the angle where resonance (light absorption) is occurring and dynamically shifting, etc. The changes in the properties of the light can be indicative of changes on the assay surface and can be recorded and processed computationally so that a representation of the change can be presented in the form of raw data, or can be analyzed or otherwise processed to provide the user information about the substances assayed against one another. In other words, the instrument in general can be used to monitor chemical and biological interactions in real time or near real-time using a label-free approach.

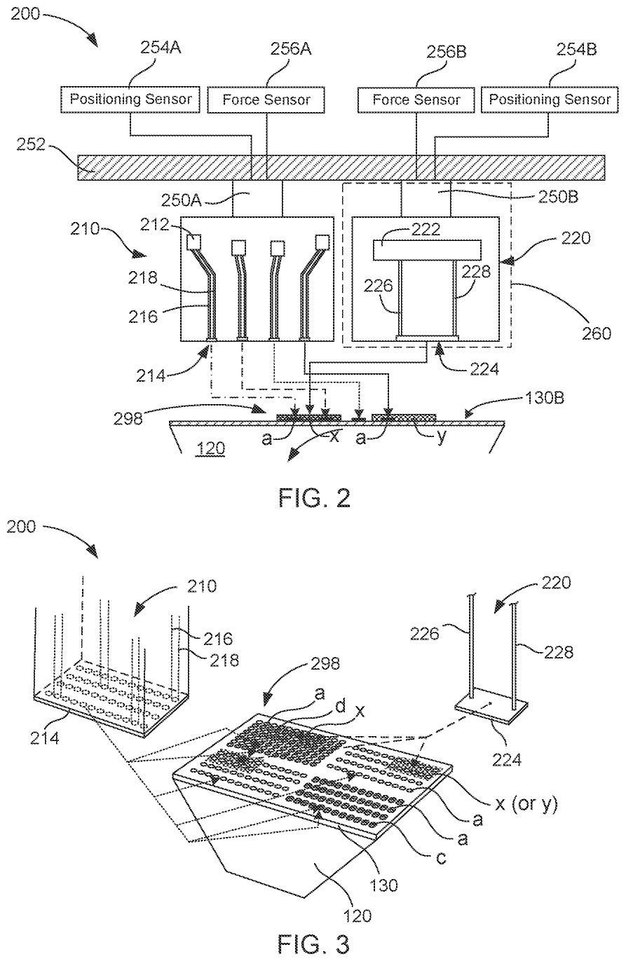

In FIGS. 2 and 3, two different examples are shown of a flow cell applicator system 200 consistent with the teachings of the present disclosure. More specifically, FIG. 2 shows a schematic cross-sectional view, and FIG. 3 shows a perspective view of a portion of the flow cell applicator system shown in FIG. 2, In this example, a 3D microchannel network which includes microchannels associated with flow cells of a flow cell assembly) can be combined with a 2D flow cell application interface (where spots are applied to a deposition surface), and automated robotic switching can occur between two different delivery systems as shown. This can provide benefits to researchers for conducting screening and multiplexing in one system with the flexibility to conduct one-on-many, many-on-one, or many-on-many individual assays in a high-throughput, automated manner while not exposing the biomolecules to unfavorable conditions. More specifically, in this example, a (first) flow cell applicator 210 can include a (first) flow cell 214, e.g., of a grouping (or array) of flow cells, for depositing a 4×12 array of spots 298 (shown in cross section in FIG. 2 with 4 flow cell fluidic circuits, each having 11 other flow cell fluidic circuits aligned in the z-direction and not visible in FIG. 2, but visible in the perspective view of FIG. 3). Thus, in this example, the (first) flow cell applicator is a multi-flow cell (MFC) applicator. The individual flow cell fluidic circuits (a total of 48) can include a (first) flow cell 214, which is fed by a fluid carrying an analyte via a first inlet conduit 216. In this example, a second flow cell applicator 220 can include a single larger flow cell fluidic circuit with a second flow cell 224 (which is an LFC applicator assembly in this example) that can be fed by a second fluid inlet conduit 226. In the particular embodiment shown, the flow cell applicator system can be a continuous flow cell applicator system, for example. Thus, the (first) flow cell applicator can have multiple respective flow paths (48 total, one flow path for each flow cell), where fluid is initiated from the first fluid reservoir 212, flows through the first fluid inlet conduit, across the flow chamber, and then out through a first outlet conduit 218. It is notable that there are four separate flow paths shown in FIG. 2, and only one “first” flow path is labeled, but the other three flow paths can be operated and implemented similar to that shown and described with respect to the first flow path and associated structure. On the other hand, the second flow cell applicator (or LFC applicator assembly) can have a flow path, where fluid is initiated from the second fluid reservoir 222, flows through the second fluid inlet conduit, across the second flow chamber, and then out through a second fluid outlet conduit 228, and in some instances into an alternative fluid reservoir (not shown). Instead of an integrated fluid reservoir as shown, LFC applicator assembly could include fluidic ports or valves that can be used to fluidly couple fluidic vessels thereto, for example. There can also be multiple fluidic ports or valves, such as a bulk fluidic port, air control ports, fluid sample ports, waste ports, etc. Regardless of how the fluid is introduced or returned or bi-directionally applied, etc., in each instance, there can be an opening where the inlet conduits and the outlet conduits feed or return the fluid into and out of individual flow cells, respectively. The opening is not shown, but can be located where the conduit connects with a wall surface of the flow cell.

It is noted that the terms “first” and “second” are used herein and throughout the present disclosure. In some instances, the term “third” may be used. These terms are meant to be relative to one another only in the context in which they are mentioned, and further, do not infer any order of use that any one of these terms should be associated exclusively with a specific component. For example, the flow cell applicator 210 could be referred to as the “second flow cell applicator” and second flow cell applicator 220 could be referred to as the “first flow cell applicator” with no consequence. In some instance, the “first” flow cell applicator may be referred to as simply a “flow cell applicator,” as the term “first” is simply used for clarity when describing the flow cell applicator relative to a second (or third, or fourth, etc.) flow cell applicator. Thus, these may be described as a flow cell applicator and a second flow cell applicator in some instances, which refers to the same two structures unless the context dictates otherwise. As another example, if a first flow cell applicator applies a first group of substance spots, and then applies a second group of substance spots, a second flow cell applicator can apply a third group of substance spots (from a multi-flow cell applicator) or a single spot (from an LFC applicator assembly), and so forth.

It should also be noted that a wide variety of other examples are possible. For example, flow cell applicators can include flow cell application interfaces with arrays of 4×24, 8×12, 6×8, 6×16, 8×24, and other arrangements to create 48, 96, 192, 384, 768 or other numbers of spots can be manufactured and used in place of the 4×12 flow cell application interface described above.

Conduits may also be referred to as channels, microchannels, microfluidic channels, canals, micro-canals, microtubules, tubules and/or tubes, where the terms are used to describe a fluid pathway. The terms “inlet conduit,” “inlet microchannel,” or “inlet microtubule” may be the first or second conduit, and the terms “outlet conduit,” “outlet microchannel,” or “outlet microtubule” may be the alternative conduit of the pathway. In some embodiments, which conduit is the inlet conduit varies as a substance flows back and forth between the conduits. For the purpose of describing the invention, “inlet” or “outlet” may be used to reference the proximal end of the respective conduit with respect to the location of the deposition chamber/printing orifice. Thus, inlets or outlets may be reversed, and outlets may become inlets or inlets may become outlets.

The conduits can be micro-scaled, such as microchannels and/or microtubules. These conduits are used to guide the substance(s) to and from the area of spot deposition on the deposition surface, wherein the flow through the microchannel or microtubes produces a high surface concentration in a specific region. Each deposition region can be individually addressed with its own microfluidic channel, which microfluidic channels may be assembled such that a large number of deposition regions may be addressed in parallel. A flow cell of a flow cell applicator can provide fluid flow by an inlet and an outlet microfluidic channel, and the flow cell can be adapted to form a seal with the deposition surface such that a sample fluid flowing through the flow cell can deposit a substance from a sample fluid onto a deposition substrate. The fluid can be injected into an inlet of a first conduit, flowed to the deposition spot area via a first microfluidic channel to the orifice, and then flowed out through a second conduit.

In one embodiment, the first and second conduits can be connected to a single fluid reservoir, thereby allowing presentation of the same material to both or all surfaces, or for recycling of the fluid and any substances contained therein.

In another embodiment, the first conduit of a microfluidic channel is connected to a first reservoir and the second conduit of the microfluidic channel is connected to a second reservoir. A plurality of microfluidic channels may be configured such that the first conduit of each microfluidic channel is connected to a common first reservoir and the second conduit of each microfluidic channel is connected to a common second reservoir. In another embodiment, each individual first and second conduit of a microfluidic channel is connected to a separate first and second reservoir. In some embodiments, for example, the fluid reservoirs can be wells of a 96-well standard microplate. The first conduit can be connected to a first well, and the second conduit can be connected to a second well. With this example being provided, there can be really any practical number of fluid reservoirs used, and the fluid reservoirs can include an open surface, can be within enclosed chambers, can be vented or unvented, etc.

Returning now to FIG. 2, individual z-axis positioners 250A, 250B can be adapted to alternatively position and seal the first flow cell applicator 210 and second flow cell applicator 220 on an assay surface 130B, which in this instance can include a surface of a sensor chip positioned on a solid optical material 120, e.g., optical prism. The assay surface may or may not include a supplemental coating but can typically include ligands attached to a surface thereof. As a note, the ligands can be pre-applied prior to running the assay, or the ligand can be immobilized (attached, adsorbed, etc.) on the surface by flowing the ligand through a grouping, e.g., array, of flow cells of the flow cell applicator system 200, In the particular embodiment shown, the positioning assembly comprises a z-axis positioner or z-axis actuator (moving the flow cell toward and away from the sensor substrate). In further detail, the positioning assembly can further include a switching mechanism 252 to switch between multiple flow cell applicators, which in this example is illustrated as a linear track, but could be a robotic arm or some other mechanism that can be used to switch back and forth between multiple flow cell operational subassemblies which include flow cell applicators, Thus, the individual z-axis positioners can position the flow cell applicator, and more particularly the flow cell application interface, over the deposition surface of the sensor and then lower them (z-axis lowering) to seal the orifices of the flow cell(s) 214, 224 against the deposition surface. It is noted that the z-axis positioners can be adjusted along x- and y-axes with coarse and fine adjustment, e.g., to position the flow cell(s) over the sensor substrate, for example. On the other hand, the track can be used to switch between the first and second flow cell applicators, in one example. Other mechanical systems can be used for switching between flow cell applicators other than a track, such as mechanical arms, rollers, or other systems. The combination of the z-axis positioner(s) and the flow cell applicator switching mechanism, e.g., track, mechanical arm, rollers, sliders, etc., can be referred to generally as the “positioning assembly.” Thus, for clarity the positioning assembly refers to the assembly of z-axis positioners and switching mechanism used to switch between multiple flow cell applicators. Z-axis positioners can be adjusted laterally along the x- and/or y-axis, but not for switching, but rather for alignment adjustment, etc.

Optical or other types of positioning sensors 254A, 254B can help the z-axis positioners position the flow cell applicator, and force sensors 256A, 2563 can help the z-axis positioner seal the flow cell application interface (and individual flow cells thereon) against the deposition surface. Though a track system (x-axis and/or y-axis switching) and multiple vertical z-axis positioners (z-axis substrate application) is shown by way of example, the systems described herein can include other positioning assemblies adapted to alternatively position and seal the first flow cell application interface and second flow cell application interface on the deposition surface. In some embodiments, the positioning assembly can be automated. Using such an automated system, researchers can carry out high-throughput experiments with greatly reduced labor time. Alternatively or additionally, there can be x-axis and y-axis adjustments on the individual z-axis positioners for adjustment and alignment of the flow cell(s) with the deposition surface.

The z-axis positioner can include robotically controlled motors and sensors to position and seal the flow cell application interfaces to the deposition surface. For example, the positioning assembly can include positioning sensors, e.g., optical positioning sensors, force sensors, and other sensors to monitor the location of the positioning assembly in 3D space. In one example, one or more force sensors can be associated with the flow cell applicators or with the deposition surface to measure the force applied by the flow cell applicators to the deposition surface. A specific predetermined magnitude of force can be associated with a sufficiently fluid-tight seal of the individual flow cell orifices against the deposition surface. The positioning assembly can be configured to lower the flow cell applicator onto the deposition surface and stop lowering when the predetermined force is reached. In another example, the positioning assembly can have a “hard setup,” in which the components of the system are assembled with sufficient tolerance that lowering the flow cell applicator by a predetermined amount forms a fluid-tight seal between the flow cell application interface and the deposition surface without the need of a force sensor.

The positioning assembly can include one or more motors to position the flow cell applicators relative to the deposition surface. In some examples, the positioning assembly can move the flow cell applicators while the deposition surface remains still. In other examples, the positioning assembly can move the deposition surface while the flow cell applicators remain still. In still further examples, the positioning assembly can move both the flow cell applicators and the deposition surface.

The positioning assembly can include any arrangement of motors or other actuators for alternatively sealing the flow cells of the first and second flow cell application interfaces to the deposition surface. For example, the positioning assembly can include robotic arms that can raise and lower, rotate, swing, or otherwise move the flow cell applicator(s), or the deposition surface, e.g., sensor, can be moved, or both. In some examples, the flow cell(s) of the first and second flow cell application interfaces can be maintained in a common plane throughout the process of positioning and sealing the flow cell(s) of the first and then the second flow cell application interface to the deposition surface. In one example, the flow cell applicators can be movable along a linear track. The first and second flow cell applicator can move linearly above the deposition surface and then lowered onto the deposition surface. Robotically controlled stepper motors can be used to move the flow cell applicators predetermined distances. The first and second flow cell applicators can both be attached to translation structures that can move as a unit, or separately, in the linear direction along the linear track and vertically to contact the deposition surface. Thus, both flow cell applicators can be switched laterally, e.g., x-axis translation, using a switching mechanism without requiring a separate x-axis translation mechanism for each flow cell applicator.

A force sensor and positioning sensor may also be associated with each flow cell applicator. The positioning sensors aid in positioning the flow cell applicators (and flow cells thereon) over the deposition surface, and the force sensors aid in creating a sufficient seal with the deposition surface. In another example, the first and second flow cell applicators can be in a fixed position, and the assay surface (e.g., test surface of a sensor chip of SFR sensing system) can be moved relative to the flow cell applicators. In still other examples, both the flow cell applicators and the assay surface can be movable. In this embodiment, the deposition surface moves to form a seal with the flow cell(s) of the first and second flow cell application interfaces alternatively. A force sensor and positioning sensor associated with the deposition surface can aid in positioning and sealing the deposition surface with the flow cell(s) of the flow cell application interfaces.

The positioning assembly can also include any other arrangement of actuators, motors, sensors, and other equipment that is sufficient to alternatively position and seal the flow cell(s) of the flow cell application interface to the deposition surface. Therefore, the positioning assembly is not limited to the specific embodiments described above.

The position of the flow cell applicator(s) may thus be translated by stepper motors, servos, or any other similar device such that it may print multiple arrays of samples on to the assay surface of the target. A group of substance spots for sensor chip deposition can include 2 or more spots, for example, and may be arranged in any number of rows and columns or other array arrangement. When a grouping of flow cells, e.g., array of flow cells, of the flow cell applicator may be finished printing, the flow cell applicator may translate and begin to print another array directly next to the previously applied array or intercalated with the previously applied array. A new array may be applied iteratively until a desired number of spots or density is achieved on the assay surface of the sensor chip. In one embodiment, the flow cell applicator may be translated to a new position to print on a cleaning slide with a cleaning solution used to clean flow cell application interface before starting or continuing to print. In another example, the flow cell applicator may be translated to another location to print on multiple slides, or to print interstitially relative to other previously deposited spots (or in preparation for future spot positions that may be reserved for a future assay).

In one example, a flow cell or a grouping (or array) of flow cells can be primed with a carrier solution. When printing has been completed, the applicator assembly translates (vertically) away from the assay surface of the target. The flow cell applicator can be removed from the assay surface of the sensor chip, and the LFC applicator assembly can be translated in position to be directly above the face or facial surface of the optical prism (with the sensor chip applied thereto or deposited thereon). The LFC applicator assembly can then translate vertically downward to dock on to the top face of the optical prism (or metal layer). A gasket(s) or orifice(s) located about the flow cells at the flow cell application interface can be used to seal the individual flow cells against a face of the solid optical material (prism) or a sensor chip applied to or placed on the optical prism face. In some instances, the flow cell application interface can be of a material where no separate gasket is needed. The sealed area between the flow cells and the sensor chip, e.g., a thin metal layer in some instances associated with an optical prism, forms an enclosed chamber, which was previously an open chamber prior to docking against the sensor chip.

The actuators, sensors, and other components of the positioning assembly can be controlled by a processing unit. The processing unit can be incorporated into the system, such as an integrated computer. Alternatively, the processing unit can be an external unit, such as a personal computer. The positioning assembly can transmit data to the processing unit and receive instructions from the processing unit through a wired or wireless connection. The processing unit can also control other components of the system, such as pumps and/or valves for flowing fluid through the flow cell applicators, pumps and/or valves for flowing air or gas for liquid fluidic control, devices for refilling fluid reservoirs, devices for changing deposition substrates, biosensors, and so on.

Generally, a system for depositing substances onto a deposition surface in accordance with the present disclosure can include at least one flow cell applicator with multiple flow cells. This first flow cell applicator having multiple flow cells (multi-flow cell applicator) can include multiple fluid inlet conduits to feed a fluid to the multiple flow cells. This can allow the flow cell applicator to deposit multiple spots of different substances onto the deposition surface simultaneously. The system can also include a second flow cell applicator. In some cases, the second flow cell applicator can have a single flow cell fed by a second fluid inlet conduit, e.g., an LFC applicator assembly. In other cases the second flow cell applicator can have multiple flow cells, similar to the first flow cell applicator, e.g., a second multi-flow cell applicator. The flow cell applicator system can further include a positioning assembly adapted to alternatively position and seal the flow cell(s) of the first flow cell applicator and second flow cell applicator (at the flow cell application interface) on the deposition surface (in either order).

In further detail, however, the positioning assembly shown and described in FIG. 2 can also be fine-tuned to position and then reposition the same flow cell applicator, e.g. the first flow cell applicator, and/or a second similarly configured flow cell applicator (not shown, but could be similar to that shown as first flow cell applicator 210) at an offset location relative to previously deposited spots. In FIG. 3, for example, four different arrays of spots are shown as white spots which are labeled generally as spots “a.” Other spot locations can be then applied therewith using the (first) flow cell applicator 210 or another similar flow cell applicator also having multiple flow cells. For example, a second set of spots can be applied interstitially in an overlapping manner relative to spots “a,” which are shown as spots “b” in the lower right quadrant of FIG. 3. Alternatively, the second set of spots can be interstitially applied in a non-overlapping manner, such as shown with respect to spots referenced as “c” in the upper right quadrant. Then, as shown in FIG. 3, for example, the larger “second” flow cell applicator (or third flow cell applicator in the case where two prior spots were applied) can be used to deposit larger overlapping deposition spots (LFC applicator assembly), denoted in FIG. 3 as spot “x.” In FIG. 2, it is noted that only type “a” spots and type “x” spots are shown, but as can be seen in FIG. 3, various combinations of spots can be applied, depending on the nature of the experiments to be conducted on the assay surface.

As a note, as shown, the second flow cell applicator 220 shown in FIGS. 2 and 3 can be an LFC applicator assembly, and the z-axis positioner 250B can be coupled thereto to provide positioning (x- and y-adjustments for alignment and/or z-axis translation for docking and undocking) of the second flow cell 224 (or large flow cell) relative to the deposition surface/assay surface 130B. This collection of components can be collectively referred to as a large flow cell (LFC) operational subassembly and is shown generally at 260.

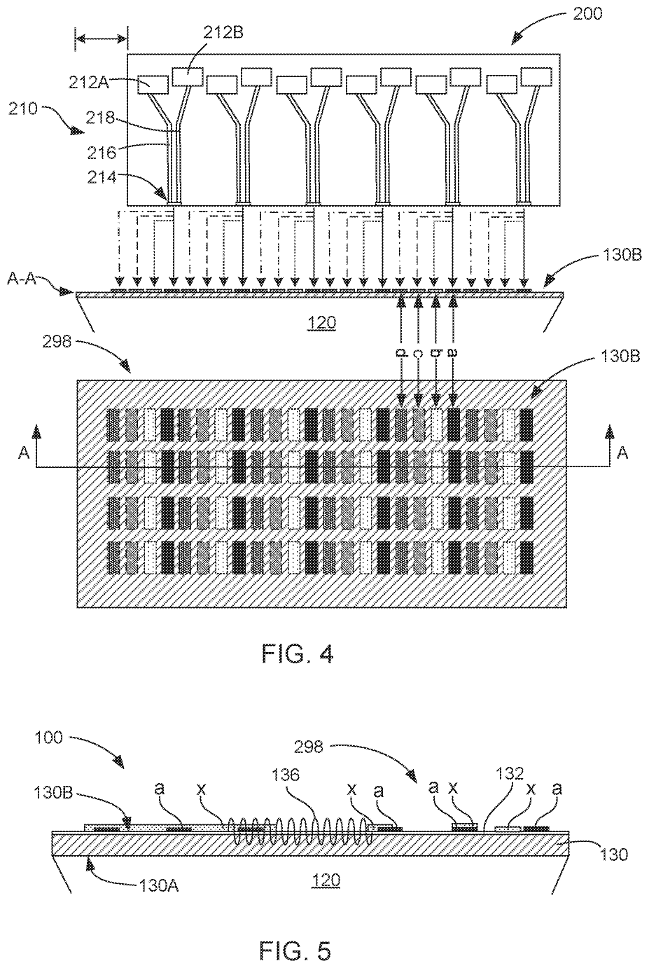

In further detail, and as shown in FIG. 4, and by a more specific example in FIG. 5, another flow cell applicator system 200 can include a (first) flow cell applicator 210 and can include similar structures as the flow cell applicator described in FIGS. 2 and 3, as the “first flow cell applicator,” namely a grouping (or array) of flow cells including a first flow cell 214, e.g., spotting chambers, individually fed by first inlet conduits 216, with individual flow paths initiated from fluid reservoirs 212, respectively flowing through the first fluid inlet conduits, across the first flow chambers, and then out through the first outlet conduits 218. In this example, the fluid reservoirs are not a single reservoir where the supply and the return are the same reservoir, but rather, there is a fluid supply reservoir 212A and a fluid return reservoir 212B. In some examples, fluid can flow bi-directionally so that the fluid return reservoir becomes the supply location and the fluid supply reservoir becomes the return location, e.g., fluid flowed bi-directionally back and forth across the group of flow cell chambers from fluid reservoirs 212A to 212B, and then from 212B to 212A, and so forth. The fluid reservoirs could likewise be replaced with valves or ports for fluidly coupling fluid reservoirs thereto, for example. In operation, the flow chambers can be pressed against the assay surface 130B, which can include a sensor chip, e.g., film or coupon of gold, silver, etc., to seal the respective orifices of the flow chambers against the assay surface. Then the fluid is flowed according to the flow paths described above. Once complete, six (6) spots shown as black (labeled as spots “a”) remain on the assay surface of the sensor. Once deposited, the flow chambers are undocked from the assay surface, and a positioning assembly (not shown, but shown in FIGS. 2 and 3 and described by way of example above) can move the flow cell applicator slightly to one side of the spots denoted as the “a” spots, where a group of “b” spots may then be applied to vacant space between previously applied spots “a,” and one of the “b” spots is applied outside of an end “a” spot. Then, the group of substance spots shown as the “c” spots and the group of substance spots shown as the “d” spots can be applied similarly. This process or system of printing spots of a second, third, fourth, etc., array between previously applied spots of an array can be referred to herein as “interstitial” printing or depositing. A top plan view of the A-A cross-section provides another view of an assay surface with interstitially applied spots. Notably, a combination of printing (or depositing) spots, interstitial printing, printing partially or fully overlapping spots (as shown in FIGS. 2 and 3), using large flow cells in combination with a group of small flow cells, etc. can be implemented using the systems and methods described herein.

That being stated, as more and more spots may be applied on a common assay surface, even for separate or different experiments, e.g. the group of substance spots identified as the “a” spots may be for one experiment and the group of substance spots identified as “b” and “c” may be for a second experiment conducted a month later, keeping track of the experimental data can get more complicated. Thus, in accordance with examples of the present disclosure, any of a number of systems can be implemented for mapping, tracking, and/or locating, e.g. spot finding, areas or regions of interest on an assay surface 130B. For example, one such system may include using radio frequency identification (RFID) device(s) that identify the assay chip and refer to stored memory. The memory can be on the chip or on the instrument or at another location. In another example, fixed locations can be tracked using software and/or hardware memory or logic, which is correlated with robotics. Thus, these systems can be used for implementing either or both of location mapping and/or location finding technologies. For example, a user can print an array on an assay surface in the form of sample spots and can then at a later time carry out a “spot find” function based on previously mapped and stored locations or based on a chemical or optical sensor that is able to identify locations where spots have been applied compared to locations where spots have not been applied. In other examples, certain spots could be dedicated to print detectable code on the surface that identifies what locations were applied, and what locations remain unapplied, or may even be specific enough to provide information about the substances applied at the respective spot locations. Alternatively, a user can record the positions of the spots for future reference and the mechanical relationship between the spot locations and the apparatus can be retained so that the relationship can be used to locate appropriate spots for further fluid interrogation. These reference marks, for example, may be placed on either surface of the optical prism or sensor chip to provide a landmark for the spot finding software. This reference mark or marks can provide a known location for which the location of the spots may be indexed in both planar directions on a surface of the optical prism or sensor chip. This reference may be particularly useful for applying spots at later times than an initial application if the applicator is removed from the instrument. The later prints may be more difficult to find using image analysis, so a hard reference allows interstitial printing even without successful spot finding.

In one example, the assay surface of the sensor chip can be marked with a position marker. The position marker can be in the form of cross hairs, a logo, a set of etches, or any other similar method of creating a mark on the assay surface of the sensor chip. The position marker can be analyzed by optical systems and can allow for spot finding software to establish positions and orientations of target areas/spots relative to the position marker. Regardless of how the position marker is applied or how it is shaped, the images can be taken by the optics system described herein and analyzed by software to establish distances from spots and the orientation of the group of substance spots previously applied.

In more detail regarding recording and finding procedures, in one example, a Radio Frequency Identification (RFID) device can be used to map, track, relocate, etc., spots and a computer or the device itself can be used to record locations and spot identity, and furthermore, to use that information for tracking and location purposes as well as for sample analysis in some examples. The RFID device can be attached directly to the solid optical material, e.g., optical prism, or other structure having a fixed relationship with the assay surface. The RFID device or a computer associated with the RFID device can store location as well as other information specific for each experiment, e.g., time, date, sample ID, sample position, etc. Thus, software, hardware, and/or optics can work together for this and other purposes. In further detail, the RFID can be bonded to the optical prism in one example, or in another example, can be otherwise associated with the optical prism in a way that is reliable enough to accurately locate applied spots. If bonded to the optical prism, it can be reused until all the spot locations have been used, e.g., including interstitial spots in some examples, or the optical prism sensor is ready to be discarded. In further detail, an optics map can be created using software to process assay surface imagery. These and other systems can provide or allow for point to point correlation of applied spots.

Recording spot locations and/or finding spot locations can have several benefits. One benefit might be to allow a user to stop working temporarily and then, using recording and/or finding processes, be able to easily pick up where the user left off before the break. Another benefit could relate to the utility of allowing for a second, third, or fourth group of sample spots to be applied next to the original (or previously applied) array, which could enhance throughput, reduce user cost per assay, increase the usable area of the sensor chip, etc. This latter example can be referred to as “interstitial printing,” Typically, printing in the field of SPR or other similar technologies use an applicator, such as a flow cell application interface (or contact printhead), to deposit a single line, or a group of substance spots, or even a more ordered array of spots. Interstitial printing would allow for the printing of additional arrays adjacent to previously deposited spots. Using recording and/or finding approaches, as well as a finely tunable printer that can move slightly adjacent to a previously applied array, additional spots can be applied to the assay sensor, including spots that may or may not be related to the previously applied spots. In other words, more spots can be applied to an assay sensor, or multiple types of spots can be applied to an assay sensor for unrelated experiments. The former may benefit from providing more spots to evaluate for a given assay. In other words, the denser the array assay surface, the more data points can be analyzed during SPR analysis of the assay. In further detail, whether or not the interstitially applied group of substance spots is related to the first group of substance spots, in either case, there can be a space efficiency realized in that more spots can be evaluated on a single assay surface (measured using the opposing optical interface surface) compared to a device that prints only a single line or single array. In either aspect, these spots can be applied to not overlap, to touch only at the border of the spots, or to partially overlap.

In further detail regarding interstitial printing, as an example, a group of 96 spot locations could be expanded to 192 spot locations, 288 spot locations, 384 spot locations, etc., e.g., 96×2, 96×3, 96×4, etc. Other numerically sized arrays of spots can be used, but 96 is used in this specific example. Essentially, the process can include depositing at a first group of substance spots at a first position by docking, e.g., pressing or mating, the flow cells of the applicator against the assay surface, flowing fluid with an analyte or other substance across the assay surface, adjusting the applicator laterally (after raising or undocking the flow cell application interface from the surface) in any direction, and re-pressing (or re-docking) the applicator with the same surface to apply a second group of substance spots. The lateral movement can be along the x- or y-axis, but could also be in a diagonal direction as well. In one example, the vertical (z-axis) movement of the flow cell applicator can be sufficient so that the individual flow cells of the flow cell application interface to clear the previously applied group of substance spots when laterally moved, and then reapplied so that there is no spot overlap of the second or subsequently applied group of substance spots relative to the first or previously applied group of substance spots. However, in other examples, the lateral movement of the flow cell application interface can be sufficient to deposit immediately adjacent spots relative to previously applied spots along borders thereof so that some contact may occur at the spot borders, or the spots of the subsequently applied array can overlap with the previously applied group of substance spots.

As shown in FIG. 5, for example, the optical sensing system 100, including the solid optical material 120, e.g., optical prism, can be used to receive and reflect light from optical interface surface 130A (or reflecting surface) of a sensor chip 130, e.g., thin film, coupon, grating, etc., applied to or placed on a facial surface of the optical prism, as previously described. As shown in this example, there may be a supplemental coating 132 (e.g., dextran coatings, carboxymethyl dextran coatings, hydrogel coatings, polyethylene glycol/carboxyl coatings, nickel nitrilotriacetic acid coatings, hydrophobic alkyl coatings, polycarboxylate coatings, protein coatings, self-assembling monolayer coatings, streptavidin coatings, etc.) present on the assay surface or in the solution above the surface, as well as immobilized ligands (not shown) that may be pre-loaded on the sensor chip. Resonating electrons can be referred to as surface plasmons, shown by example as plasmon wave 136. In this specific example, spots “a” can be adjacent to spots “x,” or the “x” spots may be applied on top of the “a” spots either fully, or partially, as shown by example. In some examples, a large spot “x” can be applied over multiple “a” spots, as shown. Thus, there can be spots that are interstitially applied in a non-overlapping manner, or there may be spots applied to overlap in various ways. It is noted that in this particular example, only type “a” spots and type “x” spots are shown, but as can be seen in other FIGS., various combinations of spots can be applied, depending on the nature of the experiments to be conducted on the assay surface. Other details can be as described elsewhere herein.

In further detail regarding spot finding, such systems can be used to compensate for image drift and can also improve interstitial printing operations. For the interstitial printing, the first set of spots can be observed and found using imaging algorithms. The printing system can then use that information to move the flow cell application interface to apply the next set of spots such that they slightly overlap, if desired, or do not overlap at all. This approach can be repeated multiple times in both directions of the printing plane up to and including the point where the surface of the sensor covered with spots at available print locations, though stopping short of covering all available locations, is also acceptable. Each time the spot finding process is completed, the found spots can be added to a database of spots for that specific sensor chip. The database can be stored in either the machine memory or on a sensor chip associated with the optical prism, such as on a cartridge associated with the flow cell applicator (or the database can be stored in both places) or even in a remote location. If the database is stored on a memory device associated with the cartridge or prism, and the applicator is removed from the instrument and then reinserted, that information can be retrieved from the cartridge memory and used for new print studies using newly interstitially applied spots, or using already existing spots, etc. Thus, the sensor chip can be used as flexibly as may be desired until the sensor chip surface is full, with no remaining available print locations available for further study.

In still further detail, the flow cell shape (2D area shape used to define spot shape) can also improve efficiency and accuracy of the systems of the present disclosure. In one aspect, the flow cell application interface can individually have a 2D aspect ratio along its planar application surface which defines open-ended flow cells therein (along the x- and y-axes corresponding to the spot size that is to be applied) from 1:1.5 to 1:20, from 1:2 to 1:20, from 1:3 to 1:15, from 1:4 to 1:10, from 1:2 to 1:10, or from 1:5 to 1:20. In FIG. 4, the various spotting or flow cell shapes, or resulting spots therefrom, can have an aspect ratio of about 2.5:1 (or 5:2). This is shown by way of example. These asymmetric spots can be rectangular in shape (as shown in FIG. 4), oval in shape, or some other shape that is asymmetric or otherwise elongated, for example. Elongated flow cell based on 2D spot shapes that can be deposited, e.g., rectangular shapes, work well for purposes of improving data accuracy and provide enhanced density for interstitial printing applications. For example, with the elongated shape, lateral movement in the direction of the shorter of the two axes can provide for dense application of spots using interstitial printing. Furthermore, surprisingly, asymmetric aspect ratio spots can actually provide more accurate results than square or round spots, particularly when the direction of substance flow is along the elongated direction of the flow cell. When applied in this manner, more consistent data can be generated that is less sensitive to sample carryover.

The flow cell applicator can include any number of flow cells as a grouping (or array) of flow cells, e.g., a multi-flow cell applicator. In one variation, there may be two wells (or other fluid source/fluid receiving chambers) for each flow cell. In such an arrangement, fluid can flow back and forth (or in one direction) between the paired wells. Therefore, a multi-flow cell application surface with 1536 wells may have 768 flow cells. A flow cell applicator with 384 wells would have 192 flow cells. A flow cell applicator with 192 wells would have 96 flow cells. A flow cell applicator with 96 wells would have 48 flow cells. A flow cell applicator with 16 wells would have 8 flow cells and so on. Any other number of wells and orifices can be used as well. For example, there may be examples where a single microchannel is associated with a flow cell, or three or more microchannels are associated with a flow cell. For example, two inlet microchannels can be used to supply sample fluid to the flow cell for mixing, or the two inlet microchannels can include a valve for sequential queuing of fluid sample introduction. In this example, a single outlet microchannel (or multiple outlet microchannels) could be used to remove the fluid during fluid flow. This variation allows a pumping manifold to be placed over half of the wells and substances placed in the other half of the wells. A pump is connected to the pump manifold, and the pump then delivers alternating positive pressure and vacuum pressure. This structure may cycle the substances back and forth between the wells via the microconduits. In other examples, there may be a fluid inlet microchannel that provides fluid to a flow cell, and there may be outlet fluidics that return fluid to and from multiple flow cells to a common waste vessel or well.

As used herein, the term “pump” includes devices that can deliver positive pressure, alternating positive pressure and vacuum pressure, or just vacuum pressure. Gravity flow can be used in the pump as well. Similarly, “pumping manifold” refers to any device for interfacing between the flow cell applicator wells and the pump, regardless of whether positive pressure or vacuum pressure is being delivered. The pumping manifold may be designed to apply the same pressure to each well or to apply different pressures to each well. In some cases, a single pump and/or valve can be provided for all of the wells. In other cases, unique valves and pumps can be provided for each well.

The flow cell applicators can operate by flowing a fluid containing the desired substance over the deposition surface, so that the desired substance adheres to the deposition surface, forming a spot. Specifically, the flow cell applicator increases the surface density of the desired substance at each spot by directing a flow of the desired substance over the spot area until a high-density spot has been created. The desired substances can in many cases be probe compounds or target compounds. Examples of probes and targets that can be flowed over a surface include: proteins; nucleic acids, including deoxyribonucleic acids (DNA) and ribonucleic acids (RNA); aptamers; cells; peptides; lectins; modified polysaccharides; synthetic composite macromolecules; functionalized nanostructures; synthetic polymers; modified/blocked nucleotides/nucleosides; synthetic oligonucleotides; modified/blocked amino acids; fluorophores; chromophores; ligands; chelates; haptens; drug compounds; antibodies; sugars; lipids; liposomes; tissue; viruses; any other nano- or microscale objects; and any combinations thereof. As a substance flows over the deposition surface, it can bind or adsorb to the surface, depending on the chemistry involved in the system.

The flow cell application interface of a flow cell applicator can be adapted to form a seal with the deposition surface (with or without a separate gasket). Often the surface will be relatively smooth such as a microslide, prism, or wafer. However, the flow cell applicator and the flow cells therein may be configured to mate or dock with any surface. For example; if a surface has existing wells or canals, the flow cell application interface can be modified so that the orifices of the flow cells are able to form a seal with the uneven surface. The “flow cell application interface,” which often includes flow cell gasket(s) for sealing a flow cell against a deposition surface, refers to the flow cell application interface portion that mates with a deposition surface upon which a substance is to be flowed, such as a microarray substrate. In some embodiments, the flow cell application interface may be a flat surface regardless of the number of orifices included within the flow cell application interface. Viewing the flow cell application interface in the horizontal plane, when it is desired that the flow cell application interface be a flat surface, it is preferable that the orifices deviate from each other less than 1 mm in the vertical plane, even more preferable less than 100 microns, even more preferable less than 50 microns, even more preferable less than 20 microns, and even more preferable less than 5 microns.

In one example, the flow cell application interface can include or define orifices of the distal ends of a bundle of microtubes, for example. In this embodiment, if the orifices are circular, the flow cell application interface can be a collection of rings. In a bundle of microtubes, gaps, rather than a solid surface, may be present between the outer edges of the orifices. These gaps may also be filled in, if desired. For example, in the microtubule embodiment, the microtubes may be held together by an epoxy used to fill in the gaps between the channels. The cured epoxy and channels may then be cut and/or polished to form a smooth surface.

The flow cell application interface can be so configured that when the face is pressed against a substrate surface, a fluid-tight seal should form, so that each cavity becomes a sealed chamber defined by the walls of the cavity and the area of substrate surface onto which the cavity opens. That is, the flow cell application interface can be so configured that pressing it against the substrate is sufficient to create the fluid-tight seal. The seal ensures that a fluid moving through the conduit into each cavity/chamber contacts only the area of substrate constituting the floor of the chamber, without escaping to surrounding areas. This also ensures that portions of the surface against which the face is pressed (but are not exposed to a cavity) will receive no contact with the fluid and therefore be substantially free of any binding substance in the fluid.

The flow cell application interface can be any size or geometry. The flow cell application interface may be designed to cover a 75 mm×25 mm, a 25 mm×25 mm, a 75 mm×55 mm microscope slide, or even a 25 mm, 50.8 mm, 76.2 mm, 100 mm, 125 mm, 150 mm, 200 mm, or 300 mm wafer. Additionally, the flow cell application interface can be designed to correspond to any substrate or structure on a substrate. For example, if a substrate has ridges, the flow cell application interface may be modified to have valleys that mate with the substrate ridges or vice versa. The flow cell application interface may also be made rigid or of sufficient flexibility to conform to a substrate surface. In some embodiments, the flow cell application interface is designed so as to facilitate integrating the flow cell applicator with an analysis platform. For example, the flow cell application interface may be designed so as to seal effectively onto a substrate that can serve as the transducer face of known analysis platforms such as a surface plasmon resonance (SFR) platform.

In some embodiments, the system can include a biosensor adjacent to the deposition surface configured to detect substances on the deposition surface. In further embodiments, the deposition surface can be an optical interface surface of a biosensor. The biosensor can use detection methods based on surface plasmon resonance (SFR), critical angle refractometry, total internal reflection fluorescence (TIRF), total internal reflection phosphorescence, total internal reflection light scattering, evanescent wave ellipsometry, Brewster angle reflectometry, quartz crystal microbalance (QCM), and others. In one embodiment, the system is a dual flow cell microfluidic delivery system for a surface plasmon resonance (SFR) imager.

Components of the flow cell applicator can be manufactured from any suitable material that is compatible with the substances to be flowed through the flow cell applicator, such as silicon, silica, gallium arsenide, glass, ceramics, quartz, neoprene, polytetrafluoroethylene polymers, perfluoroalkoxy polymers, fluorinated ethylene propylene polymers, tetrafluoroethylene copolymers, polyethylene elastomers, polybutadiene/SBR, nitriles, and combinations thereof, including laminates of materials. In one embodiment, polydimethylsiloxane (PDMS) can be used, and in another embodiment, thermoplastic elastomers can be used. Such materials can allow compression about the orifice to facilitate sealing of the orifice against the deposition surface. In one aspect, the orifice can include an outer rim that protrudes and can be configured to compress and form a seal with the deposition surface.

Multichannel SPR can be used in accordance with examples of the present disclosure. Multiplex and array detection of antigen/antibody interactions in high throughput screening applications, such as drug discovery and proteomics research where many thousands of ligand-receptor or protein-protein interactions occur, can be among the most desirable for use with the present technology. The simultaneous, real-time measurement of arrays allows for real-time referencing, dosed antigen responses, and buffer/condition optimization. Additionally, dedicated control channels can be used to improve the quality of the binding data.

The systems of the present disclosure can benefit from multiple central processing units (CPUs) to handle what can be a very large amount of data generated from the observation of a group of sample spots. For example, each spot, subgroup of substance spots, or portions of a spot in the array can be processed with its own CPU or multiple CPUs to speed up analysis time and in some cases, allow real time data presentation to the user, even when there may be many data intensive activities occurring at the same time. To illustrate the data intensive processing that may be occurring, for example, i) there may be hundreds of spots, ii) each spot may include hundreds or thousands of locations corresponding to the size of a pixel, iii) each spot and pixel can be analyzed at multiple time points (many times per second), iv) multiple angles may be processed as the light energy beam angle is modified, v) mathematical operations may be performed on the relative reflected light that is detected using the detector or camera, vi) independent pixel analysis, pixel averaging, pixel bending, etc., and/or vii) spot mapping and finding, and/or viii) the like. Thus, as can be seen, a large amount of processing and data generation capability can improve performance, By processing each spot, subgroup of substance spots, or portions of a spot with its own CPU can allow for data processing power that may be timely and can even lead to real time data being provided to the user of the instrument. For example, sensorgrams can be generated in real time that show multiple curves for a single sample (multiple angles, multiple time frames, etc.) that may be separate curves or may be plotted on a single graph as multiple curves, or in some cases, multiple curves can be mathematically combined to form a single curve or smaller subset of curves that may provide additional information to the user.

In accordance with this, the systems of the present disclosure can be adapted to sensitively detect a large number of simultaneous reactions, process a large number of samples, generate large numbers of regions of interest on a sensor, perform multiple sequential processing steps, etc., as outlined above. For example, the systems of the present disclosure can include one or more specific adaptations to enhance or increase the throughput of one or more analysis systems. For example, the systems described herein can be used to generate large numbers or regions of interest on the assay surface.

In one example, the LFC applicator assembly may have one inlet and one outlet for introduction and removal of fluid at a flow chamber where the orifice of the flow cell application interface is docked on the assay surface. This one inlet and outlet can be used to flow multiple types of fluid samples sequentially, or together. For example, the inlet and outlet can be fluidly coupled to microchannels, and there can be an inlet and an outlet for each flow cell on the flow cell application interface, Thus, the inlet can be used to flow buffer and sample (analyte, probe, etc.) fully over the target area of a flow cell application interface, or independently, various inlets and outlets (and microchannels) can flow fluid with buffer and sample over many smaller flow cells of a grouping of flow cells, for example. Thus, when a flow cell application interface is docked on the assay surface of a prism, for example, buffer can be flowed within the chamber and then the flow channel can be primed by injecting a sample (analyte) into a user placed well plate, e.g., lowering the needle into the well plate or by any other similar method. In this manner, the sample can join the buffer and flow over the assay surface of the target where the flow cell application interface is docked. With flow cell application interfaces having a grouping of flow cells, buffer can be flowed over the sample of smaller target areas and different samples can be queued to flow over the buffer sample in the more discrete smaller areas. In still another example, different samples can be queued to flow directly behind one another, or small flow chambers may direct one specific sample to flow over a target area of the assay surface while a valve may direct a second sample to flow over a different target area of the assay.

The term “sensing substrate” or “substrate” can be used herein generally to describe the structure or combinations of structures where material can be deposited or applied for optical or non-optical sensing. For example, a sensing substrate can include i) a solid optical material, e.g., optical prism or structure of some other shape used for shaping an optical beam(s); ii) a sensor chip, e.g., material layer(s) such as a thin (metal) film, (metal) coupon; or grating structure, etc.; iii) a solid optical material in combination with a separable sensor chip (metal, grating, etc.) where the sensor chip is removable or can be placed on or attached to the solid optical material, etc.; iv) a solid optical material with a sensor chip in the form of a film applied or adhered thereto; v) an array of electrochemical sensors on a silicon substrate of similar surface; and/or vi) an array of thermal sensors on a mechanical substrate; vii) etc. The sensing substrate, if included with a sensor chip (as a modular component or as a film) can have an assay surface on one side and an optical interface surface on the other side, e.g., SPR; or the sensor chip can include an assay surface on one side with the optical interface surface being on the same side. In further detail, the “sensing substrate” can further be defined to include any substrate on which material can be deposited for an assay and which can also provide for optical sensing of the deposited material (directly or indirectly). Examples can include i) an opaque substrate (e.g., paper, plastic, silicon, ceramic, metal, etc.); and/or ii) transparent or translucent substrates, such as may be used for beam shaping, filtration, etc., e.g., optical prism for shaping optical beam.

The term “solid optical material” refers to any solid shape of optical material where light can enter and interact with a deposited sample, directly or indirectly (SFR), e.g., optical prism for beam shaping, or some other beam shaping configuration. In many instances, an optical prism will be described with some specificity. It is noted, however, that the prism can be any shape that is suitable for shaping light energy for use with the sensing substrate in accordance with examples of the present disclosure.

The term “chip” or “sensor chip” refers to a data collection component used for measuring surface interactions, A sensor chip may include a thin layer(s) of material (such as a metal film or a film of another material, for example) applied to a solid optical material, a grating structure, or a coupon of material (such as metal or other material, for example). The sensor chip does not include the solid optical material but may be applied to the solid optical material. The sensor chip can include multiple surfaces, including an assay surface where chemical or other interactions can occur, and an optical surface where optics can sense the interactions. Specifically, in an SPR configuration and some other similar types of sensor configurations, the assay surface can be positioned opposite the optical interface surface. In other configurations, however, the assay surface and the optical interface surface can be the same surface, or there can be a different spatial relationship between these two surfaces. Regardless, the “sensor chip” may be preloaded with a supplemental coating(s), ligand(s), or any other material(s) that may be useful for evaluating substance interactions. The sensor chip may be referred to as a “thin metal layer” or “thin layer” in some more specific examples, or as a “metal coupon” or “coupon” in other specific examples. It is noted that in some examples, the sensor chip may be affixed or attached to the solid optical material (as a film or adhered) or can be set in place in contact with a facial surface of the solid optical material (as a sensing substrate that is modular), for example. For clarity, in another context, the term “chip” can alternatively refer to a component that uses memory for storing data, and thus can be referred to more specifically as a “data chip,” “memory chip,” or the like.

The term “SPR sensor” or “SPR sensing system” refers to surface plasmon resonance sensing systems, including a light energy source, a sensor chip with an assay surface and an optical interface surface (and in some cases a solid optical material as shown in FIG. 1, for example), and a detector to receive reflected light from the optical interface surface. The term “sensor” in this context does not imply a single structure but is a system of structures that work collectively to generate SPR data and images, for example. The SPR sensor includes substructures that are sometimes referred to as “sensors,” such as the “optical interface surface” of the sensor chip or the detector or camera (imager) that receives reflected light from the optical interface surface.

The term “assay surface” refers to a surface of a sensor chip, e.g., thin metal film, metal coupon, grating, etc., of a sensing substrate, e.g., sensor chip with or without a solid optical material, where material may be spotted with a printing system, and where chemical interactions can occur. In the context of SPR, the assay surface can be one side of a sensor chip that may include supplemental coatings, pre-applied ligands, etc., and can be spotted or applied for generating substance interactions.

The term “optical interface surface” refers to a surface of a sensor chip, e.g., thin metal film, metal coupon, grating, etc., that interacts optically with other components of a more general “sensor” system. The optical interface surface may be the same surface as the assay surface, but in the case of SPR, the optical interface surface is the opposing surface relative to the assay surface. In other words, specifically with SPR, optical sensing can occur at a detector after reflection(s) occurs from the optical interface surface, and thus, the optical interface surface can sometimes be referred to as an SFR “reflecting surface.” For clarity, with SFR, the optical interface surface is not the same surface where chemical or other substance interactions are occurring, e.g., occurring at the assay surface. However, it is noted that in other systems other than SPR, the optical interface surface and the assay surface may be the same surface.

The term “sample” can be used to refer to fluidic compositions that include particles, molecules, compounds, or other species of materials that are used to conduct experiments on the assay surface, which are sensed using the optical interface surface of a (sensor) chip. The sample can be an analyte, particle, probe, or immobilized ligand, etc., depending on the context. Sometimes “sample” is used with another term for further context, such as “sample substance,” “sample ligand,” “sample spot(s),” etc. Samples may also include other material(s) or carrier fluids, such as liquid vehicle, buffer solution, etc.

The term “spot” refers to a sample applied at a discrete location on a sensing substrate, such as an assay surface of a sensor chip. The sample can be applied as a fluid sample that dries, or can remain undried prior to application of a second sample. Sometimes spots are applied by a flow cell applicator, and then other spots are applied adjacently or overlaid (partially or fully) with other “spots” of typically a different sample (different substance, different substance concentration in a fluid sample, different spot size, etc.)

The term “array” means an arrangement of spots, but does not necessarily require rows and columns, but in some examples, may include rows and columns.

The term “buffer” means a fluid that can be used to carry a sample (of any type) from one location to another, and which is not particularly interactive with the material being tested, More generally, the term “liquid vehicle” includes liquid formulations that can be used to carry a sample.

What is claimed is:

1. A flow cell applicator system, comprising:
a flow cell applicator including multiple flow cells to deposit multiple substance spots on a deposition surface;
a positioning assembly to position, to dock, and to undock the multiple flow cells relative to the deposition surface, wherein the substance spots can be deposited when the multiple flow cells are docked on the deposition surface; and
a spot deposition identifier operably associated with a processor to:
record data related to substance spots as applied on the deposition surface,
identify data related to substance spots previously deposited on the deposition surface, or
both.

2. The flow cell applicator system of claim 1, further comprising the deposition surface as part of the flow cell applicator system.

3. The flow cell applicator system of claim 2, wherein the deposition surface is an assay surface of an optical sensor.

4. The flow cell applicator system of claim 3, wherein the optical sensor is an SPR sensor.

5. The flow cell applicator system of claim 1, wherein the multiple flow cells are arranged on the flow cell applicator to create a high-density microarray of deposited spots which includes an average of at least 1 spot per mm², wherein the multiple flow cells are arranged to create spatial separation between immediately adjacent flow cells.

6. The flow cell applicator system of claim 5, wherein the multiple flow cells individually associated with their own pump.

7. The flow cell applicator system of claim 6, wherein pumps individually associated with individual flow cells are integrated into channels flowing either to or from the individual flow cells.

8. The flow cell applicator system of claim 5, wherein the spatial separation is such that biomolecular interactions occurring at locations of individual substance spots do not interfere with immediately adjacent biomolecular interactions occurring at immediately adjacent substance spots.

9. The flow cell applicator system of claim 1, wherein the data that is recorded by the spot deposition identifier associated with the process includes data related to: locations of substance spots as deposited on the deposition surface, sizes of substance spots as deposited on the deposition surface, area covered by substance spots as deposited on the deposition surface, identities of substance spots at the locations, groupings of substances spots with a common property, deposition quality of substance spots as deposited on the deposition surface, or a combination thereof.

10. The flow cell applicator system of claim 1, wherein the data that is identified by the spot deposition identifier associated with the process includes data related to: locations of substance spots as deposited on the deposition surface, identities of previously deposited location spots, substance spots at the locations, group of substances spots with a common property, or a combination thereof.

11. The flow cell applicator system of claim 1, wherein the spot deposition identifier includes an optical sensor to identify locations of previously deposited substance spots.

12. The flow cell applicator system of claim 11, wherein the optical sensor is associated with a processor that identifies locations of the substance spots based on images of the surface or variations in the sensed signal.

13. The flow cell applicator system of claim 1, wherein the positioning assembly is operable to cause the multiple flow cells of the flow cell applicator to:
translate the multiple flow cells along an x- or y-axis relative to the deposition surface, wherein translation along the x- or y-axis includes lateral translation along an x-axis, a y-axis, or a combination of the x-axis and the y-axis translation relative to a deposition surface, and
translate the multiple flow cells along a z-axis relative to the deposition surface, wherein translation along the z-axis includes movement to dock and to undock the multiple flow cells relative to the deposition surface.

14. The flow cell applicator system of claim 13, wherein movement to dock the multiple flow cells results in closing open ends of the multiple flow cells by pressing the multiple flow cells at the open ends against the deposition surface with sufficient force to seal the multiple flow cells against the deposition surface, and movement to undock the multiple flow cells includes separating the multiple flow cells at the open ends from the deposition surface with sufficient clearance for x-axis translation, y-axis translation, or both the x-axis and the y-axis translation.

15. The flow cell applicator system of claim 1, wherein the positioning assembly is automated to dock and undock the multiple flow cells relative to the deposition surface.

16. The flow cell applicator system of claim 1, wherein the positioning assembly is controlled to dock and undock the multiple flow cells at a plurality of locations relative to the deposition surface.

17. The flow cell applicator system of claim 16, wherein the plurality of locations includes a first location on the deposition surface and a first interstitial location on the deposition surface relative to the first location upon x- or y-axis translation and z-axis translation of the flow cell applicator.

18. The flow cell applicator system of claim 17, wherein the x- or y-axis translation includes both x- and y-axis translation.

19. The flow cell applicator system of claim 17, wherein the multiple flow cells are spatially aligned as an array in rows and columns along the x- and y-axes, and wherein there is sufficient spacing between adjacent flow cells for interstitially applying a group of substance spots relative to an initially applied group of substance spots without overlap.

20. The flow cell applicator system of claim 17, wherein the plurality of locations further includes a second interstitial location on the deposition surface relative to the first location and the first interstitial location upon x- or y-axis translation and z-axis translation of the flow cell applicator.

21. The flow cell applicator system of claim 17, wherein in addition to the first location, there are from 4 to 8 interstitial locations upon x- or y-axis translation and z-axis translation of the flow cell applicator.

22. The flow cell applicator system of claim 17, wherein the multiple flow cells have a length and/or width such that a whole number of individual flow cells can be interstitially printed between an initially applied group of substance spots without overlap in either the x or y direction.

23. The flow cell applicator system of claim 17, wherein the first interstitial location is proximate enough to the first location that an interstitially applied group of substance spots applied at the first interstitial location partially overlaps or contacts at edges thereof substance spots applied at the first location.

24. The flow cell applicator system of claim 1, further comprising a second flow cell applicator operably associated with the positioning assembly, wherein a second flow cell applicator is a larger flow cell applicator with a larger flow cell that is sufficiently large to overlay a plurality of substance spots applied by the flow cell applicator.

25. The flow cell applicator system of claim 1, further comprising a second flow cell applicator operably associated with the positioning assembly, wherein the positioning assembly is controlled to dock and undock the multiple flow cells of the flow cell applicator and the multiple flow cells of the second flow cell applicator to provide for application of substance spots generated by the flow cells of the second flow cell applicator to be applied at a first interstitial location relative to application of substance spots generated by the multiple flow cells of the flow cell applicator.

26. The flow cell applicator system of claim 1, wherein the multiple flow cells have an aspect ratio greater than 1.5.

27. The flow cell applicator system of claim 1, wherein the multiple flow cells have an aspect ratio greater than 2.

28. The flow cell applicator system of claim 1, wherein the multiple flow cells are individually associated with a fluid microchannel to flow liquid through a flow cell using the microchannel.

29. The flow cell applicator system of claim 1, wherein multiple flow cells are individually associated with secondary microchannels for flowing a common liquid through the respective flow cells.

30. The flow cell applicator system of claim 1, further comprising air or gas microchannels for introduction of air or a gas into the flow cell applicator system.

31. A method of applying and interacting with a substance on a deposition surface, comprising:
docking multiple flow cells of a flow cell applicator onto a deposition surface;
flowing fluid containing a substance through the respective flow cells to deposit a first group of multiple substance spots on the deposition surface;
undocking the flow cell applicator; and
engaging a spot deposition identifier with the deposition surface, the flow cell applicator, the multiple substance spots, or a combination thereof to record data related to the multiple substance spots as applied on the deposition surface, to identify data related to substance spots previously deposited on the deposition surface, or both.

32. The method of claim 31, further comprising:
re-docking the flow cell applicator or docking a second flow cell applicator also including multiple flow cells at an interstitial location on the deposition surface relative to the first group of multiple substance spots; and
flowing fluid containing substances through the multiple flow cells after re-docking or docking to form a second group of multiple substance spots.

33. The method of claim 32, wherein re-docking the flow cell applicator or docking a second flow cell applicator and flowing fluid to form the second group of multiple substance spots occurs prior to engaging the spot deposition identifier.

34. The method of claim 32, wherein re-docking the flow cell applicator or docking a second flow cell applicator and flowing fluid to form the second group of multiple substance spots occurs after to engaging the spot deposition identifier.

35. The method of claim 32, wherein the second group of multiple substance spots are interstitially positioned relative to the first group of multiple substance spots.

36. The method of claim 31, wherein the deposition surface is an assay surface of an optical sensor.

37. The method of claim 31, the spot deposition identifier identifies data, records data, or both identifies data and records data.

38. The method of claim 31, wherein the spot deposition identifier includes an optical sensor to identify locations of previously deposited substance spots.

39. The method of claim 37, wherein the optical sensor is associated with a processor that identifies locations of the substance spots based on images of the surface or variations of the sensed signal.

40. The method of claim 31, wherein the multiple flow cells of the flow cell applicator has an aspect ratio greater than 1.5.
